(19) United States
(12) Patent Application Publication
(10) Pub. No.: US 2005/0256962 A1
(43) Pub. Date: Nov. 17, 2005

(54) Method for updating a web client on a non ip based home network, and devices for implementing the process

(75) Inventors: Denis Mischler, Thorigne Fouillard (FR); Valerie Crocitti, Saint Armel (FR); Christophe Delaunay, Rennes (FR)

Correspondence Address: Joseph S Tripoli;Thomson Licensing Inc, Patent Operations, P O Box 5312, Princeton, NJ, 08543-5312, US

(73) Assignee: Thomson Licensing S.A., F-92100 Boulogne-Billancourt (FR)

(21) Appl. No.: 10/507,248

(22) PCT Filed: Mar. 10, 2003
(86) PCT No.: PCT/EP03/03190

§ 371 Date: Sep. 10, 2004

(30) Foreign Application Priority Data
Mar. 12, 2002 (EP) 02290612.7

(51) Int. Cl. G06F 15/16

(52) U.S. Cl. 709/230

(57) ABSTRACT

The invention concerns a method for implementing an update mechanism between an HTTP gateway and a web client, both connected to a non-IP based network, characterized by, said non IP based network having event management capabilities, the steps of: by the web client, subscribing with a local event manager for notification of events comprising information of an update of a data object of the HTTP gateway; by the HTTP gateway, sending said event on the non-IP based network when the update occurs; by the web client, receiving said event and requesting transmission of the updated data object from the HTTP gateway.

The invention concerns a method for establishing a communication between an HTTP gateway and a web client on a non-IP based network, in particular in the case where the network is based on the HAVi standard.

A home network may be composed of several sub-networks using different technologies. For example, a non-IP based home network can be connected to an IP-based network. The communication of a web browser in a home device located on the non-IP home network to a web based service on the IP-based network typically involves the use of three main software components, a web client located in the device on the home network, a web server hosting the service on the IP based network and a gateway (or equivalent interface device) between the home network and the IP-based network, acting as a web proxy. This proxy could be located in a bridge device connected both to the home network and the IP-based network.

The regular behavior of a web application involving a web browser and an HTTP server is as follows. The web client makes an HTTP request to the server and gets back a response from the server. The client normally always initiates the communication. For some applications, a mechanism, called push, has been imagined to allow the server to make the client aware of the existence of new content available on the server. The standard way of doing so is to use a mechanism like the Remote Method Invocation (RMI) to allow the server to provoke a request of the new content from the client or to directly push data from the server to the client.

The problem to be solved is to implement such a push method when the client is on a non-IP based network that doesn't have any mechanism such as Remote Method Invocation. An example of such network is a digital home network based on IEEE 1394 and implementing the HAVi specification.

The invention concerns a method for implementing an update mechanism between an HTTP gateway and a web client, both connected to a non-IP based network, characterized by, said non IP based network having event management capabilities, the steps of:
by the web client, subscribing with a local event manager for notification of events comprising information of an update of a data object of the HTTP gateway;
by the HTTP gateway, sending said event on the non-IP based network when the update occurs;
by the web client, receiving said event and requesting transmission of the updated data object from the HTTP gateway.

In this embodiment, the HTTP gateway may act as a regular web client connected to an IP-based network for the web server delivering the service on the IP-based network. The HTTP gateway can implement a regular push mechanism such as Remote Method Invocation to be aware of the update of information of the web server, but any other method can be imagined. On another hand the HTTP gateway implements the event-based mechanism according to the embodiment to push the updated data to the web client on the non-IP based network. Event based mechanism on non-IP network are mechanisms in which each device on the network implements an event manager. This event manager allows the device to be aware of events occurring on the network and to trigger some events on the network. Such an event manager allows the device to select the kind of event it wants to be informed of this mechanism is being referred to as ‘event subscription’.

The invention concerns also the web browser and the HTTP gateway that implements the method. In particular the invention concerns a home device hosting a web client characterized by means for registering with an event manager to receive at least one event and means for requesting transmission of updated data according to information obtained in said at least one event. The invention concerns also a http gateway characterized by means for sending events to a non IP based network, when the update of a data object occurs on a server.

Other characteristics and advantages will be described in a non-restrictive embodiment of the invention. The embodiment will be described using the enclosed figures, among which:

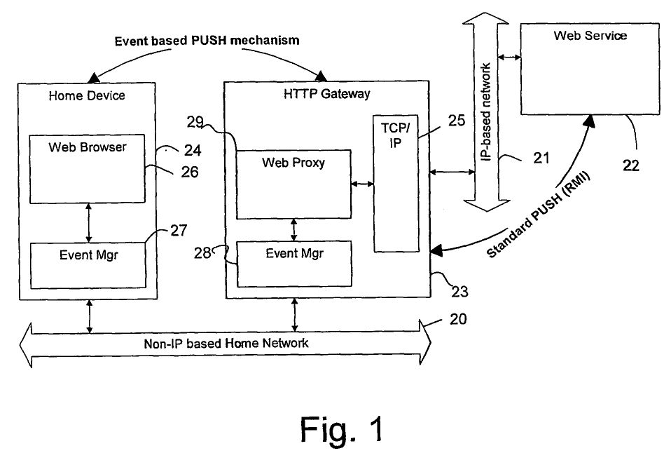

FIG. 1 is a block diagram of a non-IP based network connected to Internet via a gateway.

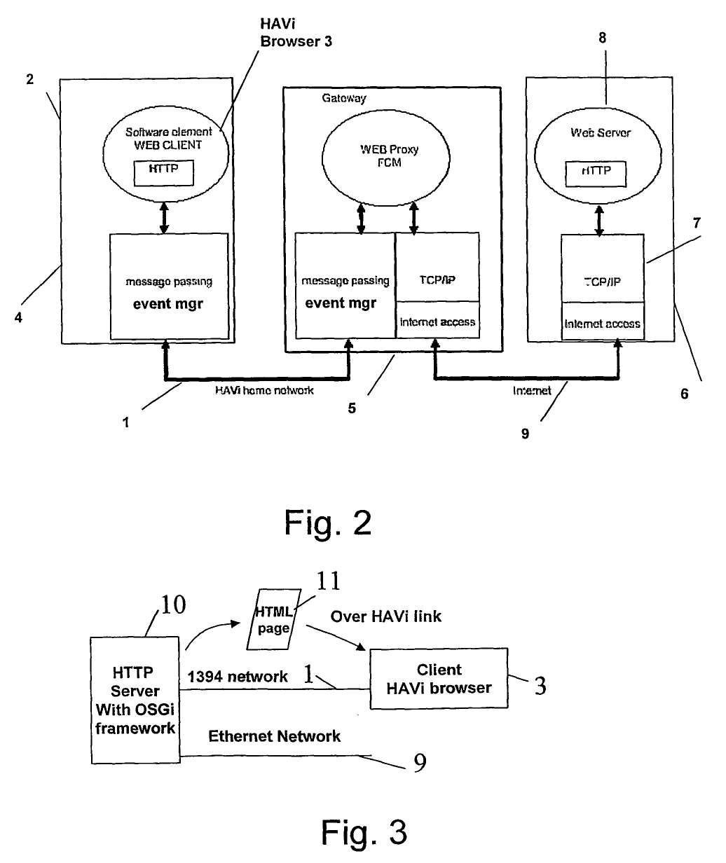

FIG. 2 is a diagram of a HAVi network linked to the Internet through a HAVi web proxy;

FIG. 3 is a diagram of a network in which the web proxy mechanism of FIG. 2 is encapsulated in an OSGi gateway;

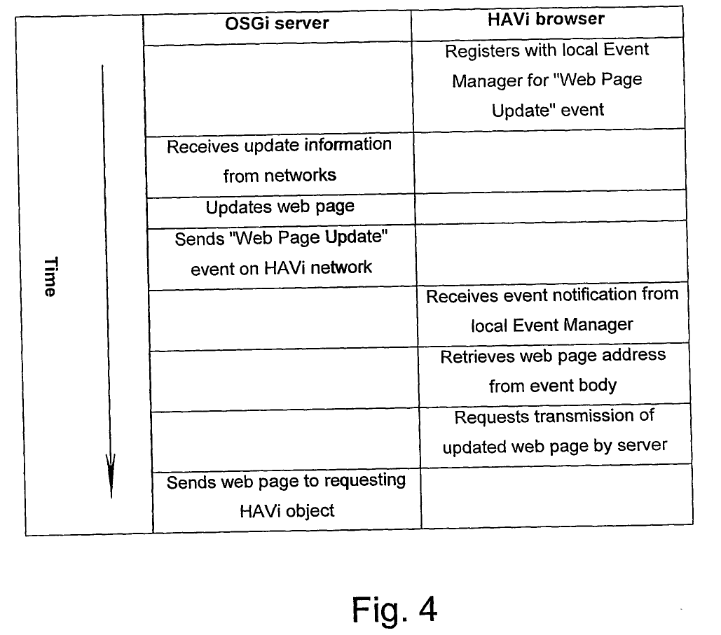

FIG. 4 is a timeline of the actions performed by a HAVi client of FIG. 3 and the OSGi gateway for updating an HTML page at the client's level, according to the present embodiment.

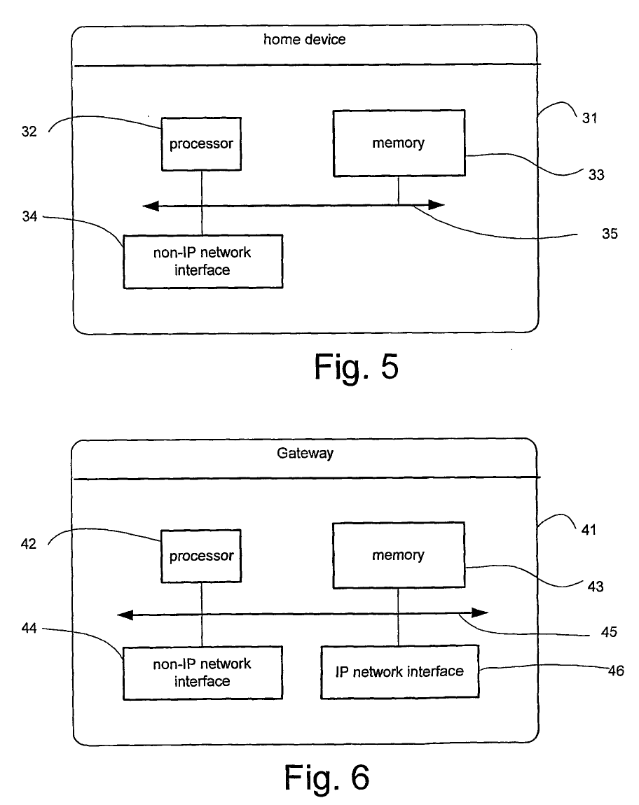

FIG. 5 is a block diagram of a home device connected to a non-IP based network.

FIG. 6 is a block diagram of a gateway connected to an IP based network.

The present and non restricting embodiment is based on the Home Audio Video interoperability (HAVi) specification, maintained by HAVi, Inc. 2694 Bishop Drive, Suite 275 San Ramon, Calif. 94583, USA, as well as on the Open Services Gateway initiative (OSGi) for which more information is available from OSGi, Bishop Ranch 2 2694 Bishop Drive, Suite 275 San Ramon, Calif. 94583 USA.

HAVi defines architecture for facilitating interoperability and development of distributed applications on home networks. It is intended for implementation on consumer electronics devices and computing devices. OSGi on the other hand focuses on the delivery of services to networks, such as a HAVi network. The OSGi Framework and Specifications facilitate the installation and operation of multiple services on a single Open Services Gateway (set-top box, cable or DSL modem, PC, Web phone, automotive, multimedia gateway or dedicated residential gateway).

FIG. 1 is a block diagram of a typical non-IP based network (20) connected to an IP-based network (21) via a gateway (23). A web based service (22) is hosted somewhere on the IP-based network. The gateway (23) has a TCP/IP stack (25) to connect to the IP-based network (21), a local event manager (28) on the non-IP based network and also the web proxy (29). On the non-IP based network, there could also be a home device (24) comprising a web browser (26) and a local event manager (27). We can see on this diagram that a standard push mechanism could be implemented between the gateway and the web service, while an event based push mechanism, according to the particular embodiment of the invention, is used between the home device and the gateway.

FIG. 2 is a block diagram of a HAVi network 1 connected to the Internet network 9. The HAVi network comprises a client device 2, which hosts a software element WEB client 3. WEB client 3 is an HTTP browser according to the present embodiment. The device 2 also contains the HAVi messaging system 4, which the local software elements can call. The Internet network comprises communication protocols and a physical layer (TCP/IP protocols and interface 7), as well as a WEB server 8. The two networks are linked by a gateway 5 hosting a WEB proxy FCM as defined by HAVi, as well as the HAVI protocols on the HAVI side and the Internet protocols on the Internet side.

This architecture allows encapsulation of HTTP messages in HAVi messages.

FIG. 3 illustrates the OSGi approach, where the mechanism of FIG. 2 is encapsulated in an OSGi gateway 10. This gateway provides the link to the Internet network and offers a global application to control the devices of the different sub-networks of the home.

FIG. 5 illustrates the architecture of a home device (31) connected to a non-IP based network. This device has a memory (33) that stores the software modules involved in the method like the local event manager, the network protocol stack and the web browser. This memory is connected via a bus (35) to the processor (32) that can execute this software and to the network interface (34) connected to the non-IP based network.

FIG. 6 illustrates the architecture of a gateway (41) connected to an IP based network. This device has a memory (43) that stores the software modules involved in the method like the local event manager, the two network protocol stacks and the web proxy. This memory is connected via a bus (45) to the processor (42) that can execute this software and to the two network interfaces (44, 46) connected to the non-IP based network and the IP based network.

According to the present embodiment, this global application is an HTTP/HTML application, accessible to the HAVI device through the HAVi browser. The OSGi application maintains pages representing the status of the Ethernet and IEEE 1394 (HAVi) networks and of the devices connected to these sub-networks. The OSGi application is informed of changes on the sub-networks through the protocols running on these sub-networks. When the OSGi application updates the HTML pages, transmission of the updated pages is carried out as follows:

For the Ethernet network, a remote method invocation is performed to push the data to a client.

For the HAVi network, the mechanism used the HAVI event manager to notify a HAVi client that a data update is required. In response to the notification, the HAVi client then requests the data from the OSGi application. In other words, it becomes the client's responsibility to pull the updated HTML data from the OSGi server.

This mechanism will now be described in more detail. Every HAVi device comprises a mandatory software element called ‘Event Manager’. Another software element of the device can register with the local Event Manager, specifying the events it would like to be notified. The Event Manager of a device has the following tasks: when an event is generated locally by its device, it transmits this event over the network, and when it receives an event from the network, it must notify all local software elements who registered with the Event Manager for notification of this event.

The services provided by the Event Manager are described in section 5.4 of the HAVi specification version 1.1. An event comprises an event identifier and an event body. Three types of events are defined: system specific events, vendor specific events and application specific events. The latter can be generated by a specific software element to inform other devices or software elements of internal changes. This event type is used in the present embodiment.

The event identifier indicates the type of the event, and the identity of the application that generated it.

According to the present embodiment, an event called “Web Page Update” is defined. The OSGI application (which is a HAVi application module) or the HAVI WEB proxy running on the OSGi server use this event to inform a client application that an HTML page has been refreshed. An identifier of the HTML page is included with the event. In the present case, the event identifier is chosen so as to unambiguously indicate the web page update. The event body contains the address of the web page itself.

The web browser 3 of the HAVi client (which is also a HAVI application module) will subscribe to its local Event Manager for the event having the identifier corresponding to the HTML page update. All HAVi components having done so with their local Event Manager will then be notified concurrently. Upon notification, these components can then send a message to the OSGi server, requesting transmission of the page identified by the address given in the event body.

FIG. 4 is a diagram of the process that has just been described.

Although the embodiment concerns HAVi and OSGi, the principle of the invention can be applied in other environments where a data push is not directly possible and where a data server needs to force a client to retrieve updated data.

While the embodiment above concerns mainly http and HTML, the invention is not limited to this context. It can be used in any environment where a push mechanism needs to be implemented in a network seeking to access a server in another network.

1. Method for implementing an update mechanism between an HTTP gateway and a web client, both connected to a non-IP based network, comprising, said non IP based network having event management capabilities, the steps of:
by the web client, subscribing with a local event manager for notification of events comprising information of an update of a data object of the HTTP gateway;
by the HTTP gateway, sending said event on the non-IP based network when the update occurs;
by the web client, receiving said event and requesting transmission of the updated data object from the HTTP gateway.

2. Method according to claim 1, wherein the event transmitted by the HTTP gateway contains an identifier of the updated data object.

3. Method according to claim 2, wherein the data object is an HTML page and the identifier is the HTML page address.

4. Device hosting a web client in a non-IP network comprising means for registering with an event manager of the non-IP network to receive at least one event and means for requesting transmission of an updated data object according to information obtained in said at least one event.

5. Device according to claim 4 wherein the event contains an identifier of the updated data object.

6. Device according to claim 5 wherein the data object is at least part of an HTML type page and the identifier is the address of the at least part of the HTML type page.

7. Device according to claim 4, wherein said means for registering with an event manager are adapted to registration with an event manager of a gateway for connection of the non-IP network to an IP network and wherein said event manager is adapted to generating said event upon detection of an updated data object on a server device of the IP network.

8. HTTP gateway for connecting a non-IP network with an IP network comprising means for sending at least one event to the non IP based network, when the update of a data object occurs on an IP server.

9. HTTP gateway according to claim 8 wherein the event contains an identifier of the data object.

10. HTTP gateway according to claim 9 wherein the data object is an HTML page and the identifier is the HTML page address.

11. HTTP gateway according to claim 8, further comprising means for receiving an event registration request from a non-IP device for notification of said object update.
